(19) United States
(12) Patent Application Publication
(10) Pub. No.: US 2018/0025418 A1
(43) Pub. Date: Jan. 25, 2018

(54) Systems and Methods for Setting Up Sale Transactions for an Online Auction

(71) Applicant: Ninkasi Technologies, LLC, West Hyannisport, MA (US)

(72) Inventors: Jefferson Dean Slater, Centerville, MA (US); Elieser J. Aschkenasy, Cleveland, OH (US)

(21) Appl. No.: 15/655,858

(22) Filed: Jul. 20, 2017

Related U.S. Application Data
(60) Provisional application No. 62/364,413, filed on Jul. 20, 2016.

(51) Int. Cl. G06Q 30/08

(52) U.S. Cl. CPC G06Q 30/08

(57) ABSTRACT

Systems and methods for setting up and conducting the sale of regulated goods using an auction are provided. The methods include receiving information of one or more auction entries from a seller through a user interface, selecting at least one from the one or more auction entries for each buyer being logged into the auction system, receiving one or more bids from the buyer through the user interface for the at least one selected auction entry, selecting one or more bids among the received bids for each of the selected auction entries for the each buyer, generating one or more sale transactions for each of the selected auction entries between a corresponding buyer and a corresponding seller and informing the generated one or more sale transactions to the corresponding buyer and the seller of the auction entry.

### CROSS REFERENCE TO RELATED APPLICATION

The present application claims priority to U.S. Provisional Patent Application Ser. No. 62/364,413, filed Jul. 20, 2016, and entitled “Systems and Methods for Setting Up Sale Transactions in an Auction System,” the contents of which is incorporated by reference herein in its entirety.

### TECHNICAL FIELD

The present disclosure relates generally to the distribution of regulated goods, such as alcoholic beverages and other controlled substances (e.g., cannabis), and, more particularly, systems and methods for providing an on-line sales platform to which artisans (i.e., those producing the regulated goods or controlled substances, such as brewers, distillers, vintners, cannabis cultivators, etc.), distributors, retailers or dispensaries, and consumers can participate so that sales and distributions of the regulated goods between the participants are efficiently managed.

### BACKGROUND

The beverage industry has seen a tremendous growth in the number of craft brewers in recent years. The number of new brewers has been doubled in the last four years, to about 4000 across the country. However, about a half-dozen large, established brands represent about 60% of total sales, and thus, such brands control a large portion of distribution networks.

Finding buyers is difficult for craft brewers, sometimes referred to more generally as artisans, because they typically cannot afford to conduct significant marketing campaigns like the established, large brands. Furthermore, distributing beer using established distributors can be disadvantageous because the distributors may be heavily influenced by the established, large brands. In some instances, artisans distribute beer through their own network, which can raise many issues, including a high set-up cost and various regulatory constraints.

The various regulatory constraints result from each state in the United States having its own regulations. More local regulations may also exist within a state, such as county, city, or town regulations. The variations in the regulations make it difficult for the artisans to manage their own distribution channels. In addition, the variations increase difficulty for the artisans to set-up sale transactions with buyers from a different region.

Another issue plaguing craft brewers is the difficulty they face in price setting. It is not easy for craft brewers to predict demands or determine a reasonable price based on the rest of the market. In particular, within the context of addressing non-discrimination, price posting, and other state regulation rules where applicable, artisans/craft brewers may want the price for various products and batches of products to be more sensitive to market demand and conditions, but they do not have the tools at their disposal to make such adjustments.

Notably, these same issues plague those distributing other controlled goods and substances as well, such as cannabis. As different states set regulations that allow the distribution and sale of cannabis, those who produce the cannabis, referred to herein as cultivators (or more broadly covered by the term artisans herein as well), and those who distribute and sell cannabis, such as dispensaries, have difficulty finding the target market, determining a fair price, and insuring that all of those involved up-and-down the sales chain are in compliance with any regulations related to such distribution and sales.

Accordingly, a new approach is required for the artisans to set-up sale transactions with buyers at an appropriate price considering actual demands, with the buyers being able to be consumers, distributors, and/or retailers/dispensaries/etc. Such an approach ideally would also allow any of the consumers, distributors, and/or retailers/dispensaries/etc. to be sellers, and the artisans to be buyers. Still further, the new approach should account for variations in regulations for each region that need to be considered when setting up the sale transactions.

### SUMMARY

Systems and methods associated with making sales of regulated goods are disclosed in the present application. More particularly, the present application discloses ways by which buyers and sellers from any point along the chain of potential buyers and sellers (e.g., consumers, distributors, retailers/dispensaries, makers/producers/artisans/brewers, etc.) can participate in an online sale, typically by way of an auction, directed to the sale of regulated goods, such as alcohol or marijuana, among other regulated goods. The systems and methods allows buyers to participate as sellers and sellers as buyers if desired. It is automated such that the systems and methods can verify the credentials, licenses, etc. are in place to allow the seller and buyer to participate in the particular sales transaction being conducted. For example, checks are performed to confirm the seller is authorized to sell the particular regulated good in the location (e.g., state, town, etc.) in which the buyer is attempting to make the purchase, and likewise, to confirm the buyer is authorized to purchase the regulated good in the location in which the buyer is making the purchase and/or the location in which the buyer and/or receiver of the purchased goods is having the purchase shipped.

In one exemplary embodiment, a method for setting up one or more sale transactions on an auction system is featured. The method includes receiving information of multiple auction entries from one or more sellers of a plurality of sellers, via a user interface of the seller(s), with the information including, but not limited to, a lot size of an auction entry of the multiple auction entries, as well as selecting at least one auction from the multiple entries for one or more buyers of a plurality of buyers who are logged into the auction system. The method further includes receiving one or more bids from at least one buyer of the one or more buyers, via the user interface of the at least one buyer, for the at least one selected auction entry, selecting one or more bids among the one or more received bids for the at least one selected auction entry, and generating one or more sale transactions for the at least one selected auction entry between a corresponding buyer of the plurality of buyers and a corresponding seller of the plurality of sellers. The method still further includes informing the corresponding buyer and the corresponding seller of the at least one selected auction entry of the generated one or more sale transactions.

The action of selecting at least one auction entry from the plurality of auction entries for one or more buyers of a plurality of buyers being logged into the auction system can include selecting at least one auction from the plurality of auction entries in view of government (e.g., country, state, county, town, etc.) regulations applicable to a good being sold in conjunction with the at least one auction entry.

The bid can include many different types of information, including, for example, a bid price, an order amount (i.e., the number of a particular good desired for purchase), and a desired sale location. In embodiments in which the one or more received bids is a plurality of received bids, the action of selecting one or more bids among the plurality of received bids for the at least one auction entry can include ordering the plurality of received bids in a descending order of the bid price, and selecting at least one bid of the plurality of received bids until a total amount of the order amount of the at least one selected bid exceeds the lot size of the corresponding auction entry. In some such embodiments, a sale price for the generated sale transaction can be determined according to the bid prices of the selected bids. For example, the sale price for the generated sale transaction can be the same as the bid priced for the corresponding bid, or the sale price can be the same as the lowest bid price of the at least one selected bid (i.e., the sale price for all winning bids can be the price of the lowest bid that was still an accepted bid). In some embodiments, the action of selecting at least one bid of the plurality of received bids can also include selecting one or more bids from the plurality of received bids that are equal to or greater than a reserve price of the corresponding auction entry.

Another example of information of an auction entry can include whether a partial sale of the good being sold is permitted. The information of an auction entry can include a flag for allowing a partial sale and, if a partial sale of an auction is not allowed and the total amount of selected bids does not exceed the lot size of the auction entry, no sale transaction is created. However, if a partial sale is allowed, selected bids can still be awarded and sale transactions can be created provided all other requirements have been met by the buyer(s) and seller(s).

In another exemplary embodiment, a system for setting up one or more auction sale transactions is provided. The system includes both a storage device and a processor. The storage device is configured to receive and store information related to a plurality of auction entries from one or more sellers of a plurality of sellers, with the information including, by way of non-limiting example, a lot size of each auction entry. The processor is in communication with the storage device to allow the processor to access and perform various functions in view of the information stored by the storage device. The processor is configured to access the information from the storage device, select at least one auction entry from the plurality of auction entries for each buyer of a plurality of buyers being logged into the auction system, and receive one or more bids from one or more buyers of the plurality of buyers for the at least one selected auction entry. The process is also configured to select one or more bids among the one or more received bids for the at least one selected auction entry, generate one or more sale transactions for the at least one selected auction entry between a corresponding buyer of the plurality of buyers and a corresponding seller of the plurality of sellers, and inform the corresponding buyer and the corresponding seller of the at least one selection auction entry of the generated one or more sale transactions.

In some embodiments, the processor can be further configured to select at least one auction entry from the plurality of auction entries for each buyer of a plurality of buyers being logged into the auction system in view of government (e.g., country, state, county, town, etc.) regulations applicable to a good being sold in conjunction with the at least one auction entry.

The bid can include many different types of information, including, for example, a bid price, an order amount (i.e., the number of a particular good desired for purchase), and a desired sale location. In instances in which the one or more received bids is a plurality of received bids, the processor can be configured to further order the plurality of received bids in a descending order of the bid price and select at least one bid of the plurality of received bids until a total amount of the order amount of the selected bids exceeds the lot size of the corresponding auction entry. In some such embodiments, a sale price of the generated sale transaction can be determined according to the bid prices of the selected bids. For example, the sale prices for the generated sale transaction can be the same as the bid price for the corresponding bid or the sale price can be the same as the lowest bid price of the at least one selected bid (i.e., the sale price for all winning bids can be the price of the lowest bid that was still an accepted bid). In some embodiments, the selection of at least one bid of the plurality of received bids can be performed such that selected bids are bids that are equal to or greater than a reserve price of the corresponding auction entry.

Another example of information of an auction entry can include whether a partial sale of the good being sold is permitted. The information of an auction entry can include a flag for allowing a partial sale and the processor can be configured such that if a partial sale of an auction is not allowed, and the total amount of selected bids does not exceed the lot size of the auction entry, no sale transaction is created. However, if a partial sale is allowed, he processor can be operable such that selected bids can be awarded and sale transactions can be created provided all other requirements have been met by the buyer(s) and seller(s).

In still another exemplary embodiment, a method for setting up one or more sale transactions on an auction system includes generating a plurality of auction entries for a plurality of batches of sales, and, for each user that is logged into the auction system, selecting one or more of the plurality of auction entries based, at least in part, on regulations governing sales between the users (e.g., the buyers) and a seller(s) of each of the auction entries. Bids are received from one or more eligible users. The bids include, by way of non-limiting examples, a bid price and an order amount (i.e., the number of a particular good desired for purchase). For each of the auction entries, one or more bids are selected among the received bids for the auction entry with the bids being disposed in a descending order of the bid prices of the received bids, the selecting occurring until a sum of the corresponding order amount exceeds an amount of the auction entry (i.e., the lot size of the good being auctioned), and a sale price is determined for the auction entry based on the selected bids. Notably, the reference to the bids “being disposed in a descending order or the bid prices of the received bids” does not necessarily require that the order actually be physically ordered in that fashion (although it could be), but rather, that a processor carrying out these methods is able to determine the order of the bids, even if those bids remain in a different order physically. The method further includes setting up one or more sale transactions for each of the plurality of auction entries, the sale transaction(s) having a determined sale price between a corresponding user and the seller of the auction entry.

In some embodiments, the action of selecting one or more bids among the received bids for the auction entry can include selecting one or more bids that are equal to or greater than a reserve prices of the corresponding auction entry. Like other exemplary embodiments described herein, a bid can include many different types of information, such as whether a partial sale of the good being sold is permitted. The information of an auction entry can include a flag for allowing a partial sale and, if a partial sale of an auction is not allowed and the total amount of selected bids does not exceed the lot size of the auction entry, no sale transaction is created. However, if a partial sale is allowed, selected bids can still be awarded and sale transactions can be created provided all other requirements have been met by the buyer(s) and seller(s).

### DESCRIPTION OF THE DRAWINGS

This disclosure will be more fully understood from the following detailed description taken in conjunction with the accompanying drawings, in which:

FIG. 1 illustrates a functional block diagram that depicts one exemplary embodiment of an apparatus for setting up one or more sale transactions on an auction system;

FIG. 2 illustrates a table that depicts one exemplary embodiment for storing information related to an auction entry;

FIG. 3 illustrates a table that depicts one exemplary embodiment for storing information related to a seller, including information about one or more locations in which the seller is authorized to make a sale;

FIG. 4 illustrates a table that depicts one exemplary embodiment for storing information related to a buyer, including information about one or more locations in which the buyer is authorized to make a purchase;

FIG. 5 illustrates a flow chart that depicts one exemplary embodiment for setting up one or more sale transactions in conjunction with an auction;

FIG. 6 illustrates a flow chart that depicts one exemplary embodiment for displaying auction entries selected for a user;

FIG. 7 illustrates a flow chart that depicts one exemplary embodiment for calculating a sale price for an auction entry;

FIG. 8 illustrates a flow chart that depicts one exemplary embodiment for creating an auction entry by a seller;

FIG. 9 (broken into three parts, #s 1-3) illustrates a flow chart that depicts one exemplary embodiment for saving an auction entry;

FIG. 10 (broken into two parts, #s 1-2) illustrates a flow chart that depicts one exemplary embodiment for displaying auction entries selected for a user;

FIG. 11 (broken into three parts, #s 1-3) illustrates a flow chart that depicts one exemplary embodiment for entering a bid;

FIG. 12 (broken into three parts, #s 1-3) illustrates a flow chart that depicts one exemplary embodiment for updating an already entered bid;

FIG. 13 illustrates a flow chart that depicts one exemplary embodiment for calculating a price for an auction entry;

FIG. 14 illustrates a flow chart that depicts one exemplary embodiment for determining a business state for a user;

FIG. 15 illustrates a flow chart that depicts one exemplary embodiment for determining a label and license territory for a user;

FIG. 16 illustrates a flow chart that depicts one exemplary embodiment for determining an auction territory for an artisan; and

FIG. 17 illustrates a flow chart that depicts one exemplary embodiment for determining an auction territory for a distributor.

### DESCRIPTION

The present disclosure addresses the issues and difficulties discussed above by providing an improved auction system that allows sellers, e.g., artisans, to find buyers, e.g., consumers, so the sellers can set-up sale transactions at an appropriate sale price. Artisans, consumers, distributors, and retailers or dispensaries can participate in the system as either buyers or sellers even though in the present disclosure sometimes the present disclosure may describe or otherwise imply a buyer as being an end user (i.e., a consumer of the regulated good) and a seller as being the maker and/or distributor at which the consumer makes the purchase (where “at” does not necessarily mean a physical location, and instead often relates to an online location). The systems and methods provided for herein can be used across all types of goods, whether low-end or high-end goods, although in some instances the systems and methods provided for herein can be applied to limited edition, high end, and/or vintage products to optimizes sales and margins for the artisan, also referred to as an original manufacturer. The present systems and methods can also help eliminate unnecessary intermediate steps from certain transactions, where allowable, such that artisans are not hamstrung by long-term contractual commitments to third parties.

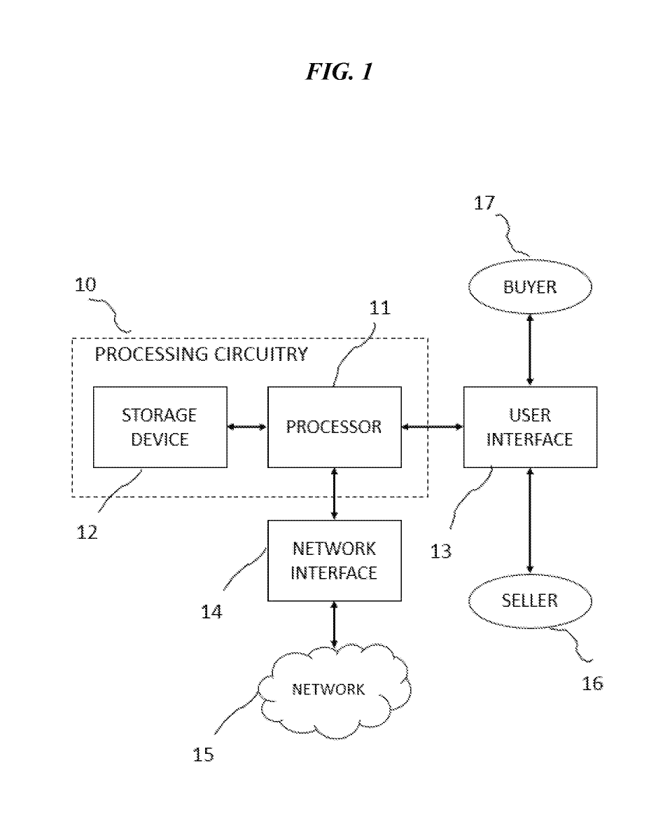

An example embodiment of the present disclosure is described in reference to FIG. 1. FIG. 1 shows certain elements of an apparatus for setting up one or more sale transactions on an auction system according to an exemplary embodiment. The apparatus of FIG. 1 may be employed, for example, on a client (e.g., a server, a workstation, or the like) or a variety of other devices (such as, for example, a network device, proxy, or the like). Alternatively, embodiments may be employed on a combination of devices. Accordingly, some embodiments of the present invention may be embodied wholly at a single device or by devices in a client/server relationship. Furthermore, it should be noted that the devices or elements described below may not be mandatory and thus some may be omitted in certain embodiments.

Referring now to FIG. 1, an apparatus configured for setting up one or more sale transactions on an auction system is provided. The apparatus may be an embodiment of processing circuitry 10 that is configured to perform data processing, application execution, and other processing and management services according to the present exemplary embodiment or other embodiments provided for herein or otherwise derivable therefrom. In one embodiment, the processing circuitry 10 may include a storage device 12 and a processor 11 that may be in communication with or otherwise control a user interface 13 and a network interface 14. As such, the processing circuitry 10 may be embodied as a circuit chip (e.g., an integrated circuit chip) configured (e.g., with hardware, software, or a combination of hardware and software) to perform operations described herein. However, in some embodiments, the processing circuitry 10 may be embodied as a portion of a server, computer, laptop, workstation, or one of various mobile computing devices (e.g., smartphones, tablets, etc.). In situations where the processing circuitry 10 is embodied as a server or at a remotely located computing device, the user interface 13 may be disposed at another device (e.g., at a computer terminal or client device such as one of the clients 20) that may be in communication with the processing circuitry 10 via the network interface 14 and/or a network (e.g., network 15).

The user interface 13 may be in communication with the processing circuitry 10 to receive an indication of a user input from a seller 16 and a buyer 17 at the user interface 13 and/or to provide an audible, visual, mechanical, or other output to the seller and buyer. As such, the user interface 13 may include, for example, a keyboard, a mouse, a joystick, a display, a touch screen, a microphone, a speaker, a cell phone, or other input/output mechanisms known to those skilled in the art. In embodiments where the apparatus is embodied at a server or other network entity, the user interface 13 may be limited or even eliminated in some cases. Alternatively, as indicated above, the user interface 13 may be remotely located.

The network interface 14 may include one or more interface mechanisms for enabling communication with other devices and/or networks. In some cases, the network interface 14 may be any means such as a device or circuitry embodied in either hardware, software, or a combination of hardware and software that is configured to receive and/or transmit data from/to a network and/or any other device or module in communication with the processing circuitry 10. In this regard, the network interface 14 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet, or other methods. In situations where the network interface 14 communicates with a network, the network may be any of various examples of wireless or wired communication networks such as, for example, data networks like a Local Area Network (LAN), a Metropolitan Area Network (MAN), and/or a Wide Area Network (WAN), such as the Internet.

In an example embodiment, the storage device 12 may include one or more non-transitory storage or memory devices such as, for example, volatile and/or non-volatile memory that may be either fixed or removable. The storage device 12 may be configured to store information, data, applications, instructions or the like for enabling the apparatus to carry out various functions in accordance with example embodiments of the present invention. For example, the storage device 12 could be configured to buffer input data for processing by the processor 11. Additionally, or alternatively, the storage device 12 can be configured to store instructions for execution by the processor 11. As yet another alternative, the storage device 12 may include one of a plurality of databases that may store a variety of files, contents, or data sets. Among the contents of the storage device 12, applications may be stored for execution by the processor 11 in order to carry out the functionality associated with each respective application. In still other embodiments, the storage device does not have to be local, such as storage associated with cloud storage. A person skilled in the art will understand how the disclosures provided for herein can be utilized in an environment in which storage is conducted remotely, such as via the cloud.

The processor 11 may be embodied in a number of different ways. For example, the processor 11 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an example embodiment, the processor 11 may be configured to execute instructions stored in the storage device 12 or otherwise accessible to the processor 11. As such, whether configured by hardware or software methods, or by a combination thereof, the processor 11 may represent an entity (e.g., physically embodied in circuitry) capable of performing operations according to embodiments of the present invention while configured accordingly. Thus, for example, when the processor 11 is embodied as an ASIC, FPGA, or the like, the processor 11 may be specifically configured hardware for conducting the operations described herein. Alternatively, as another example, when the processor 11 is embodied as an executor of software instructions, the instructions may specifically configure the processor 11 to perform the operations described herein.

In an example embodiment, processing circuitry 10 may perform setting up one or more sale transactions. The processing circuitry 10 includes a processor 11 and a storage device 12. The processor 11 may generate a plurality of auction entries for a plurality of batches of sales for goods, such as regulated goods like alcoholic beverages (beers, spirits, wines) and cannabis. The plurality of batches of sales may be stored in the storage device 12. Alternately, the processor may generate an auction entry when a seller 16 enters information for a batch of sale using a user interface 16.

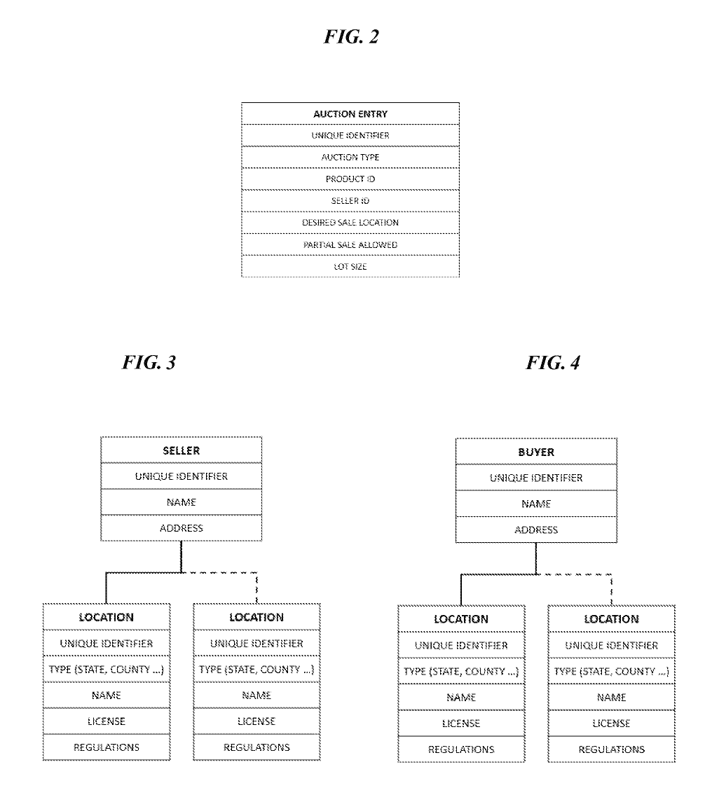

An auction entry may include an identifier for the auction entry, an auction type, a product (i.e., beer) id, information related to the product (e.g., ingredients, alcohol content, size, packaging, batch size, brewer, etc.), a seller id, a sale location, and a lot size (i.e., an amount from a production). FIG. 2 illustrates an exemplary embodiment of a table that stores auction entries, with a “field” (e.g. auction entry, unique identifier, auction type, product ID, seller ID, desired sale location, partial sale allowed, and lot size) for the particular auction being illustrated within an individual box. A person skilled in the art will recognize that the provided fields are only a small sampling of the plethora of fields that can be used to identify the good(s) being sold. For fields like “unique identifier,” a person skilled in the art will understand any number of ways by which a unique identifier can be determined, including an automated aspect that randomly generates a particular code per auction entry, an automated aspect that generates a particular code per auction entry based on information associated with the auction entry (e.g., auction type, type of product, seller, location, etc.), or an aspect that allows the creator of the auction entry to establish a unique identifier for that particular auction.

A seller may do business in one or more locations. Specifically, business states of the seller is critical since each state in the United States have its own regulations. Furthermore, local regulations may also exist within each state, such as county, city, or town regulations. Accordingly, information for business locations for a seller may be stored in the storage device 12. A seller may be authorized to perform business in a state when the seller gets a license from the state. However, there may be other regulations controlling authorization of business for each locations. Hence, for each seller, one or more locations for business and corresponding regulations may be stored in the storage device 12. FIG. 3 illustrates an exemplary embodiment of tables that store sellers and relevant information for each seller. As shown, various information about a seller can be provided, each with a “field” illustrated within an individual box. The provided for fields include unique identifier (which can be generated in any manner known to those skilled in the art, including those provided above in describing the term with respect to FIG. 2), name, and address, among others that can be included. The information associated with the seller may be displayed on a website, although any portion of that information may be kept private if desired, the control being given to the operator of the system and/or the user entering the information. Additional information that can be provided includes information about a location in which the seller is authorized to sell, with a seller being able to sell in multiple locations as shown (e.g., New York state and the Commonwealth of Massachusetts). In the illustrated embodiment, two locations are illustrated, with non-limiting examples of the “fields” that can be provided about a location including unique identifier (which can be generated in any manner known to those skilled in the art, including those provided above in describing the term with respect to FIG. 2), type (e.g., state, county, town, etc.), name, license (i.e., whether a license is required, and if so, if the license is active, expired, pending, etc.), and regulations (i.e., the relevant regulations that impact whether a sale can be made for that particular seller for that particular location). Similar to FIG. 2, a person skilled in the art will recognize that the provided fields are only a small sampling of the plethora of fields that can be used to identify the seller and the locations in which the seller is authorized to sell.

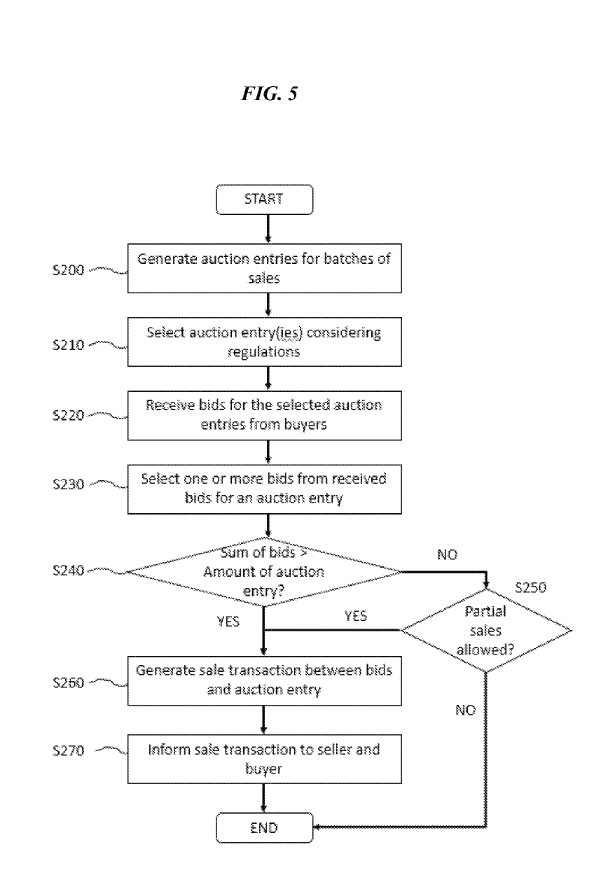

Likewise, the buyer may have similar information as a seller, with the information being able to be stored in a similar manner FIG. 4 illustrates an exemplary embodiment of tables that stores buyers and relevant information for each buyer, again with a “field” being provided in an individual box for the buyer information. The provided for fields are similar to those provided for the seller in FIG. 3 above, and thus not repeated. Any portion of the entered information can be public or private, with the option being controllable by the operator of the system and/or the user entering the information. Likewise, just as a seller can sell in multiple locations, a buyer can buy in multiple locations. In the illustrated embodiment, two locations are illustrated, with non-limiting examples of the “fields” that can be provided about a location being akin to those described above with respect to FIG. 3. Similar to FIGS. 2 and 3, a person skilled in the art will recognize that the provided fields are only a small sampling of the plethora of fields that can be used to identify the buyer and the locations in which the buyer is authorized to purchase. Further, although in the illustrated embodiment the fields for the buyer and the seller are illustrated as being substantially identical, they do not have to be. Still further, even though “fields” may have the same names in FIGS. 3 and 4 (and in other figures provided for herein), a person skilled in the art will recognize they do not necessarily include identical information. For example, information about “regulations” for a seller may be different than “regulations” for a buyer. Of course, as described herein, the present systems and methods allow for a seller to participate as a buyer and a buyer to participate as a seller in some instances, in which case the information for the same user as a buyer and a seller may be different based on the user's current participation status of a particular auction (i.e., based on whether the user is participating in a particular auction as a buyer or as a seller).

When a buyer 17 wants to access auction entries for the buyer, the processor 11 may select auction entries applicable for the buyer according to the location of the buyer and business locations of sellers of a plurality of auction entries. For example, when a buyer who does business in New York state wants to buy goods, only auction entries of the sellers who can perform business in New York state are applicable to the buyer. Furthermore, the buyer may have additional restrictions (for example, age restrictions and/or restrictions on whether a particular type of regulated good is allowed to be purchased in that state, e.g., cannabis, certain forms of alcohol, etc.). Those additional restrictions may be considered when selecting auction entries for the buyer.

The buyer 17 may check the selected auction entries for the buyer and may put bids for each auction entry that is open to receive bids. Each bid may include, for example, a location(s), a bid price, and a bid amount. When a buyer may perform business in more than one location (e.g., state), the buyer may specify one or more locations for a particular bid.

There may be a time limit for putting bids for buyers. For example, bids may be needed to be entered by 7:00 PM each day. That is, the auction system may consider bids that are entered by 7:00 PM to set sale transactions for the day.

At a certain time, the processor 11 may group bids for each auction entry. For example, a first auction entry may have four bids for the entry, and a second auction entry may have only one bid on it. The processor may order the bids for each auction entry in a descending order by the bid price. For example, when bids for an auction entry have price of $3.50, $3.60, $2.99, and $3.10, the processor may order the bids in the order of $3.60, $3.50, $3.10, and $2.99. After ordering the bids, the processor may add the bid amount of each order in the descending order until the total amount of the bids exceeds the lot size of an auction entry. For example, assuming that the amount of an auction entry is 1000 bottles, when the bid amounts of the bids are $3.60—300 bottles, $3.50—420 bottles, $3.10—350 bottles, and $2.99—400 bottles, the processor may select the first three bids because the total amount of the first three bids (1070) which exceeds the lot size (1000) of the auction entry. In this case, the seller can sell 300 bottles to the first bidder, 420 bottles to the second bidder, and 280 bottles to the third bidder. When the amount of an auction entry does not satisfy all selected bids, the buyer with the lowest bid may buy less amount than his or her bid amount.

In other situations, if the sum of bids does not exceed a lot size of an auction entry, the processor may check whether it is allowed to sell a portion of the auction entry. Some buyer may want to sell as much as possible even though there is not enough bids to sell total amount of production. For example, when the aforementioned second auction entry has an amount of 700 bottles, but it has only one bid of 300 bottles, the auction system may set a sale transaction for the 300 bottles if the auction is set to allow partial sales.

For the selected bids for each auction entry, the processor may generate or set sale transactions. Each sale transaction may include a buyer, a seller, a sale price, a sale amount, a sale location, and regulations applied for the sale. The generated sale transactions may be stored in the storage device 12.

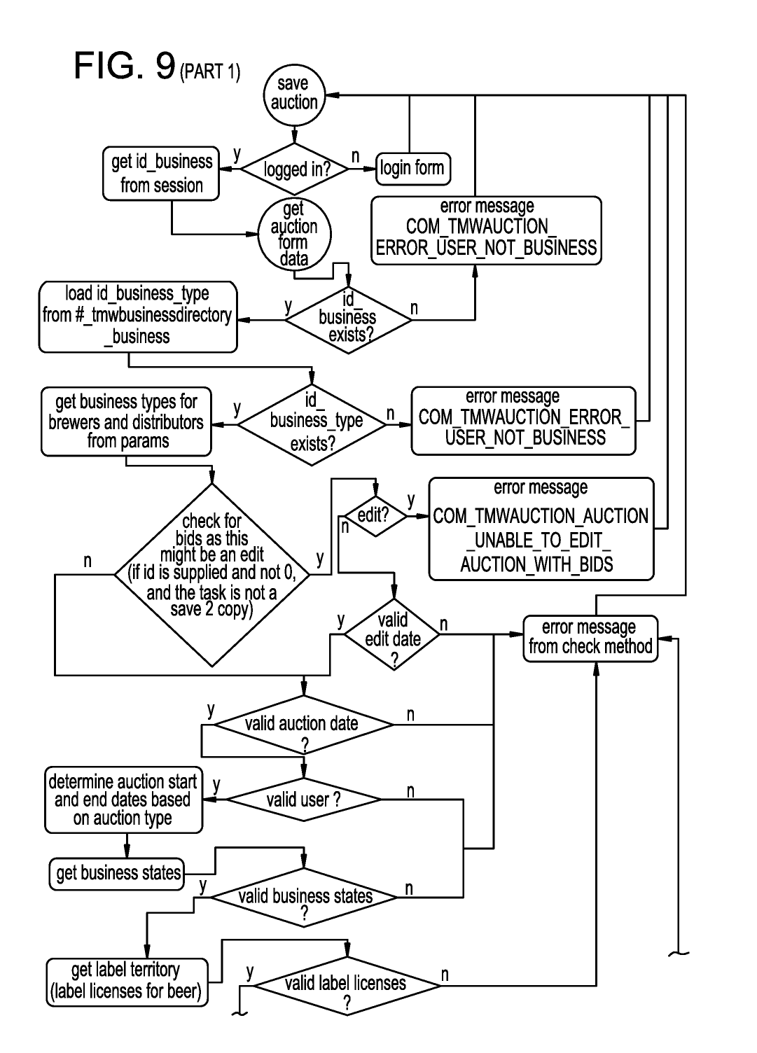

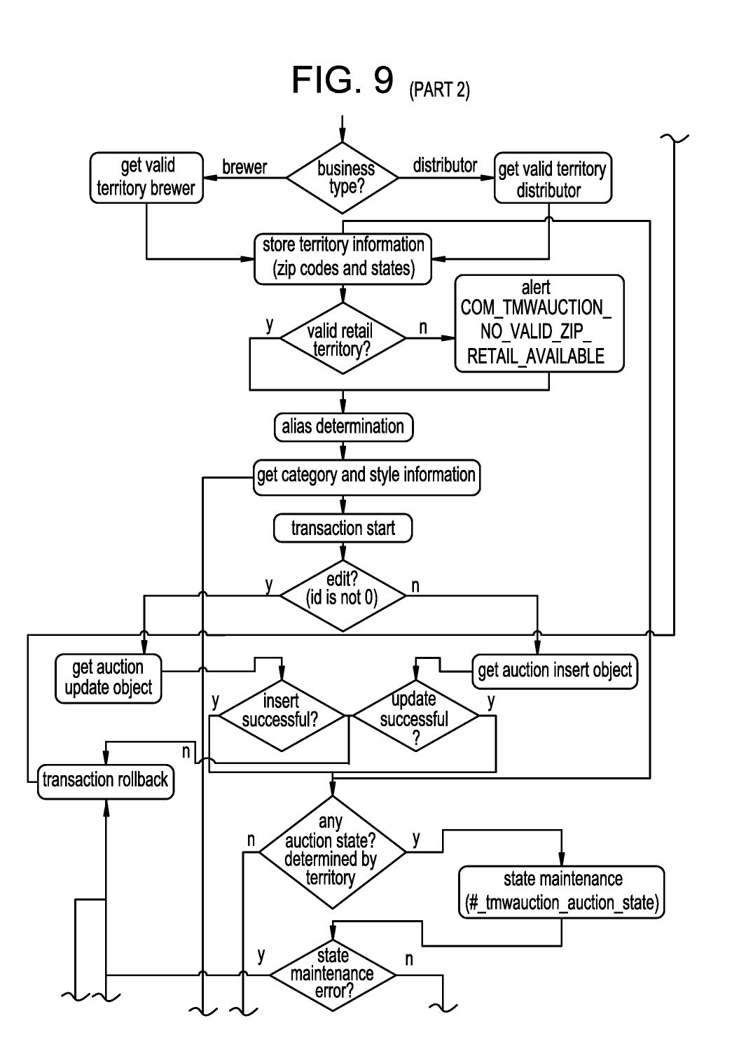

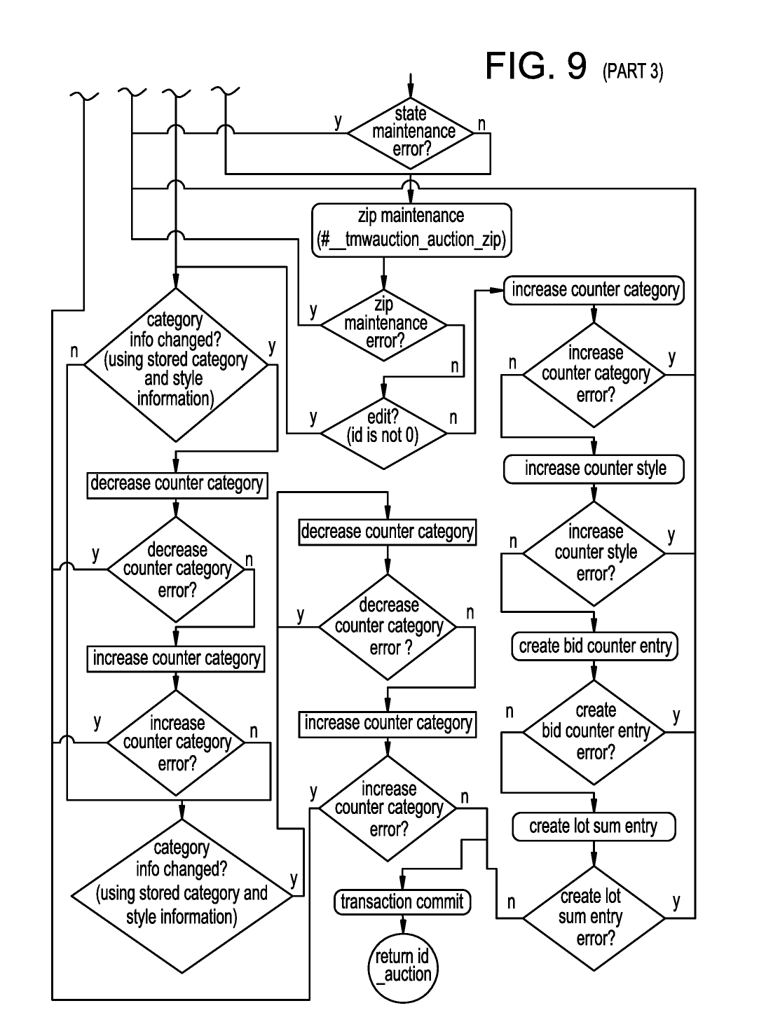

The processor may inform the generated sale transactions to corresponding buyers and sellers. The processor may display the generated sale transactions to the buyer(s) and seller(s) through the user interface 13. Alternately, the processor may send an e-mail or text message, or may utilize any other communication methods to inform the buyer(s) and seller(s) (e.g., a mobile application or other form of “app”). The buyer(s) and seller(s) may check sale transactions for them after logging into the auction system through the user interface 13. Additional aspects of the provided for systems and methods can be ascertained by reviewing the flow charts provided for in FIGS. 5-8, as well as their related descriptions. More detailed additional aspects of the provided for systems and methods can be further ascertained by reviewing the flow charts provide on FIGS. 9-17.

FIG. 5 illustrates a flow chart that depicts one exemplary embodiment for setting up one or more sale transactions on an auction system. In step S200, the auction system may generate one or more auction entries for one or more batches of sales for goods (e.g., beer, wine, etc.). The batches of sales may be stored in the storage device 12. Alternately, the processor may generate an auction entry when a seller 16 enters information for a batch of sale using a user interface 16.

For a buyer, in S210, the auction system may select auction entries applicable for the buyer according to the location of the buyer and business locations of sellers of a plurality of auction entries considering regulations applicable to buyers, auction entries, and corresponding sellers. A person skilled in the art will recognize other criteria that may cause selection for the buyer, including but not limited to desired parameters provided by the user, such as preferences of goods, preferences of sellers, etc.

In S220, the buyer may review the selected auction entries for the buyer and may put a bid for any number of auction entries. Each bid may include at least one location, a bid price, and a bid amount or lot size (i.e., the number of units or the like desired), among other parameters. When a buyer may perform business in more than one location (e.g., state), the buyer may specify one or more locations for a particular bid.

In S230, the auction system may select one or more bids received for each auction entry considering bid price, bid amount, auction amount or lot size, and/or other parameters designated by the seller. In S240, the auction system may check whether the total amount of selected bids, and the lot sizes associated with each bid that meets any other designated parameters, exceeds a lot size of an auction entry. If yes, the system proceeds to generating sale transactions (S260). However, if the total amount of selected bids, and the lot sizes associated with those bids, does not exceed a lot size of auction entry, the system checks whether partial sales is allowed for the auction entry (S250). If it is not allowed to sell partial amounts for the auction entry, the system does not generate a sale transaction for the auction entry.

For selected bids for an auction entry, the system may generate one or more sale transactions for the auction entry (S260). Each sale transaction may include a buyer, a seller, a sale price, a sale amount or lot size, a sale location, and regulations applied for the sale, among other information. The generated sale transactions may be stored in the storage device 12.

In S270, the system may inform the generated sale transactions to corresponding buyers and sellers. The system may display the generated sale transactions to the buyers and sellers through the user interface 13. Alternately, the system may send an e-mail or text message, or may utilize any other communication methods to inform the buyer and seller (e.g., a mobile application or other form of “app”).

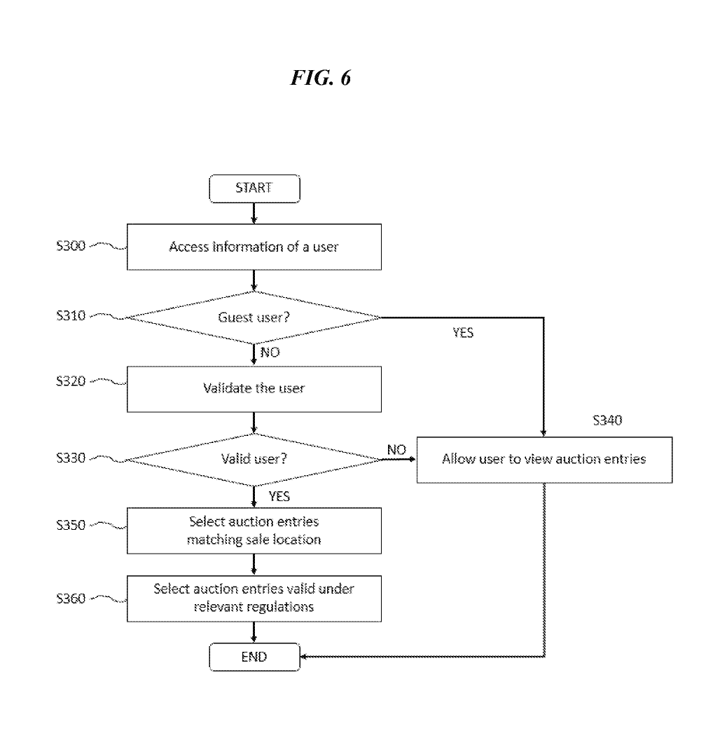

FIG. 6 illustrates a flow chart that depicts one exemplary embodiment for displaying auction entries selected for a user. More specifically, this flow chart illustrates steps for selecting auction entries considering regulations when performing step S210 of FIG. 5. In S300, when a user logs into an auction system, the system may access information of the user. The user may be a guest user who just wants to view available auction entries. If an user is a guest user, the system may allow the user to view auction entries (S310 and S340). For a guest user, a portion of the bid information, or other information associated with any auction entry, may be filtered.

In S320, if a user is not a guest user, the system may validate a license of the user. For example, the system may check whether the user has a valid liquor license to buy goods from the auction system for subsequent sail (i.e., the buyer is a distributor). If the user is not a valid user (S330), the user may still view auction entries (S340). In some instances, the auction system can be set-up to prevent users who are not valid users from seeing one or more auctions, such as a buyer who is not able to prove he or she is of the requisite age to participate in the auction.

For a valid user, the system may select auction entries that matches location of sales (S350). For example, if the user wants to buy beers to sell in New York state, the system selects auction entries applicable to New York state.

In S360, the system may select auction entries valid under relevant regulations applicable to the buyer, the seller, and the sale location. For example, in the state where the sale is happening, the license of the user may not allow buying a certain type of beverage.

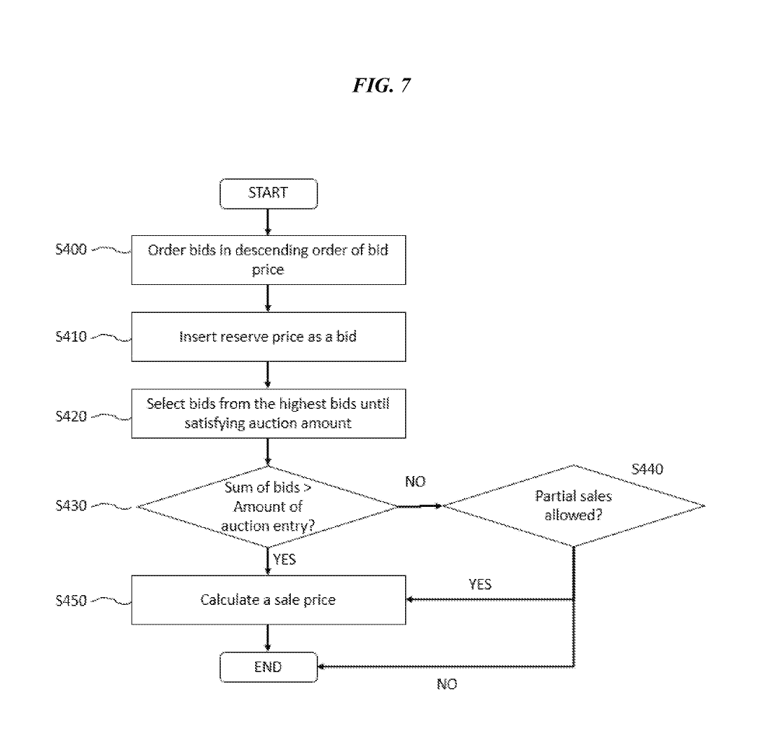

FIG. 7 illustrates a flow chart that depicts one exemplary embodiment for calculating a sale price for an auction entry, also referred to as a price discovery tool. More specifically, this flow chart illustrates steps for determining sale price for generated sale transaction between selected bids and an auction entry, which are illustrated in steps S230-S260 of FIG. 5. The auction and bidding process can serve as a Dutch-style auction, benefiting the seller by calculating a fair market value price for the goods, and benefiting the buyer by insuring the buyer equal access to any good for which the buyer is legally permitted to purchase.

In S400, for an auction entry, the auction system may order received bids for the auction entry in an descending order of bid price. For example, when bids for an auction entry have price of $3.50, $3.60, $2.99, and $3.10, the processor may order the bids in the order of $3.60, $3.50, $3.10, and $2.99. This step can be performed at any time during or after the auction closes. For example, in some instances, even while the auction is live, the step can be performed, while in other instances the system may not perform this step until after the auction closes.

In S410, a reserve price can be inserted as a bid. A reserve price can be a price the seller has determined is the absolute minimum amount the seller is willing to accept for the good(s) being sold. If bids meet or exceed the reserve price, the bids may be considered acceptable bids, while if bids fall below the reserve price, they may be considered unacceptable bids. In this way, the seller may prevent loss from sale transactions for an auction entry. In some instances, a reserve price can be a price for the full lot, which is to say that the reserve price is the minimum acceptable price allowed for a bid if the whole lot that is up for sale is being purchased. By way example, a seller may consider a reserve price to be $3.00, regardless of how many goods are being requested by the buyer, including if the whole lot is being purchased. In some other instances, a reserve price can be multiple prices, with different prices being acceptable depending on the amount of goods the buyer is willing to purchase. By way of example, a seller may consider a reserve price to be $3.00 if a buyer is purchasing one to six (1-6) goods, $2.90 to be an acceptable reserve price if a buyer is purchasing seven to twenty (7-20) goods, and $2.75 to be an acceptable reserve price if a buyer is purchasing more than 20 (>20) goods.

The system may select bids from the highest bid price until the total amount of bids exceeds the lot size of the auction entry, as illustrated in S420. The total amount of bids can be those bids that are considered acceptable, i.e., those bids that meet or exceed the reserve price. Generally, only acceptable bids can be selected bids unless a seller has provided for an exception. Turning back to the selection process more generally, in one example, assuming that an amount of an auction entry is 1000 bottles of beer, when the bid amounts of the bids are $3.60—300 bottles, $3.50—420 bottles, $3.10—350 bottles, and $2.99—400 bottles, the system may select the first three bids because the total amount of the first three bids (1070) exceeds the lot size (1000) of the auction entry. A person skilled in the art will recognize this is but one example, and that many other parameters and determinations can be made in conjunction with a Dutch-style auction, or another type of auction, in view of the present disclosures without departing from the spirit of the present disclosure.

In S430, the auction system may check whether the total amount of selected bids exceeds a lot size of an auction entry. If yes, then, the system proceeds to next step. However, if the total amount of bids does not exceed a lot size of an auction entry, the system checks whether partial sales is allowed for the auction entry (S440). If it is not allowed to sell partial amount for the auction entry, the system does not generate a sale transaction for the auction entry. When summing the total amount of selected bids, the system is summing external bid lots, which are bids from potential buyers, and does not typically consider the inserted reserve price from S410 as a bid itself.

In S450, the system may calculate a sale price for a sale transaction, also referred to as a clearing price. The system may have various rules to calculate the sale price. The system may apply bid prices of each bid as a sale price for a corresponding sale transaction. Alternately, the system may choose a lowest bid price among the selected bids (e.g., S3.10 in the example described above) as a sale price for all sale transactions for the auction entry. Regulations in the corresponding sale location may decide which method is applied to calculate the sale price, or other parameters provided for by the system and/or the user may play into the sale price determination. For example, in some states, sales from a single production (i.e., a single lot) may have same sale price for all transactions for the production.

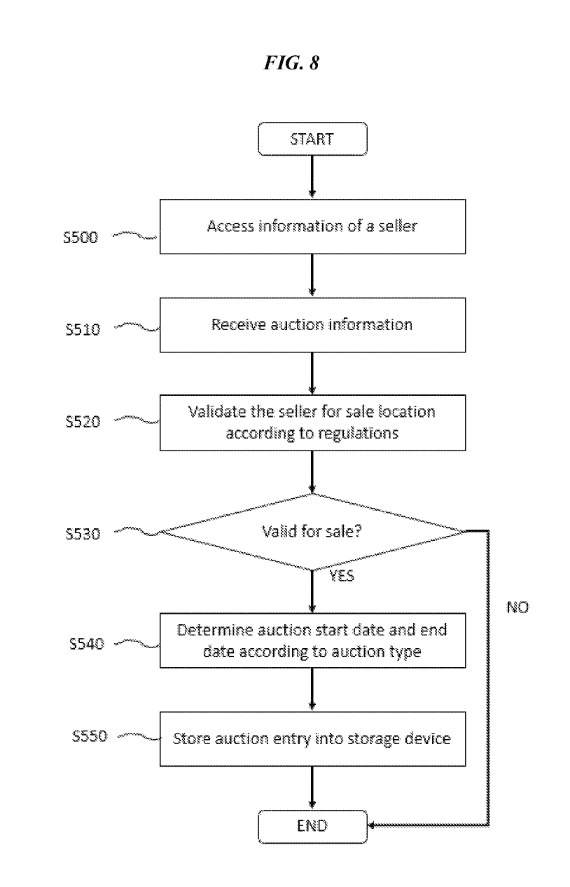

FIG. 8 illustrates a flow chart that depicts one exemplary embodiment for creating an auction entry by a seller. When a seller wants to create an auction entry, the auction system may access information of the seller (S500). The seller may enter information for an auction entry using a user interface 13 (S510). Information entered by the seller can include information provided for above as described and depicted in FIG. 2, as well as other information a person skilled in the art will recognize can be associated with the sale of a regulated good. By way of non-limiting example, a reserve price can be provided.

In S520, the system may validate the seller for a sale location that the seller enters using a user interface since the seller desires to sell his goods in the location. The system may check whether the seller has valid authorization (e.g., a license) for the entered sale location.

If the seller does not have valid authorization for the sale in the sale location, the system may give an appropriate message to the seller indicating the lack of authorization and may end the process. If the seller has valid authorization for sales in the sale location, the system may determine the start date and end date according to an auction type of the auction entry (S540). Then the system may store the auction entry into a storage device (S550), like the storage device 12. A seller may access stored auction entries created by the seller, and may modify or delete the auction entries.

Sales can occur across every state and territory of the United States, and can also allow foreign consumers to buy US-produced beer. To the extent the systems and methods provided for herein are implemented to account for international regulations, they systems and methods can also be used for sales and distribution within and between foreign countries.

While the flow charts in FIGS. 5-8 provide a solid overview of some of the key transactions that can be performed by the system on behalf of sellers and buyers, additional details about these transactions, sub-components thereof, and other related transactions and methods are provided for in the flow charges provided in FIGS. 9-17. Such flow charts provide a substantial amount of detail about the various actions that can be carried out in conjunction with the systems and methods provided for herein, and thus a step-by-step accounting of each illustrated aspect is unnecessary in view of the rest of the disclosure and knowledge of those skilled in the art. A person skilled in the art will understand that the illustrated flow charts are merely exemplary methods for carrying out the various methods provided for herein, and one or more of the steps can be eliminated, enhanced, or otherwise modified without departing from the spirit of the present disclosure.

FIG. 9 illustrates a flow chart that depicts one exemplary embodiment for saving an auction entry. As shown in FIG. 9, a seller wanting to start an auction for goods, such as regulated goods like alcoholic beverages (e.g., beers, spirits, wines) and cannabis, logs into an auction system. Among other features, the seller may be validated for whether the seller has a valid business state and a label license and/or whether it is the appropriate time for the auction to be conducted. Once the seller is validated, the seller may create a new auction entry or update existing auction entries created by the seller. The chart in FIG. 9 references the seller, and is buyer agnostic. Additional details about how to set-up, save, and modify an auction entry can be discerned from the flow chart of FIG. 9 by a person skilled in the art, as well as in view of the descriptions and illustrations provided for with respect to FIGS. 5 and 8, among other disclosures provided for herein.

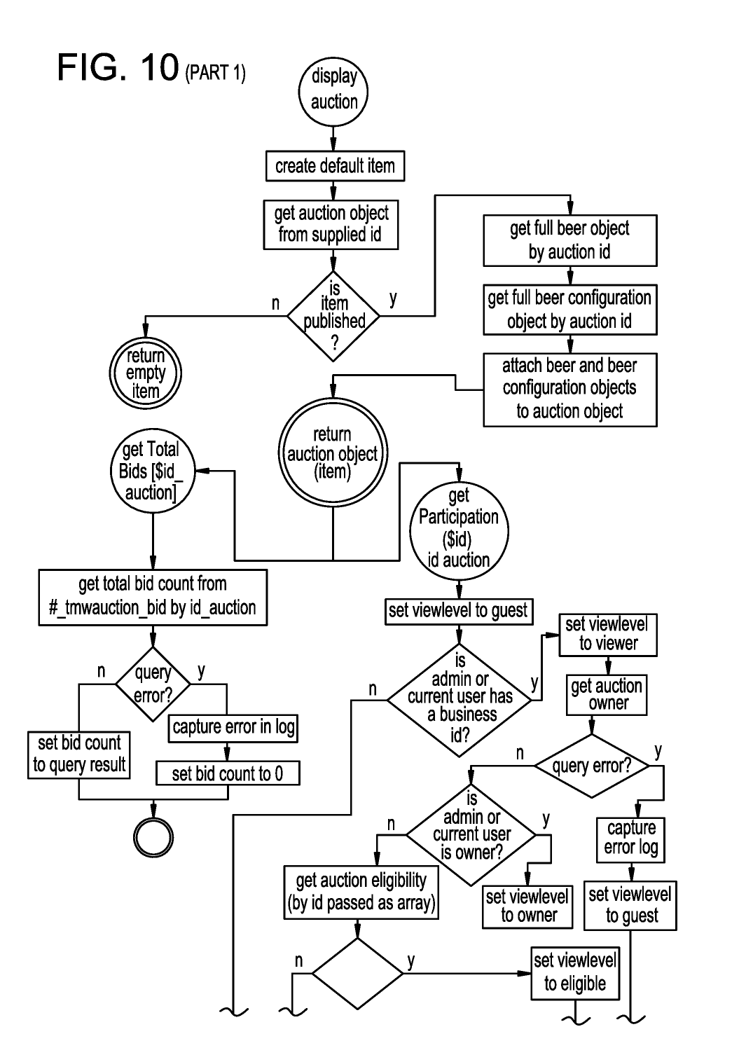

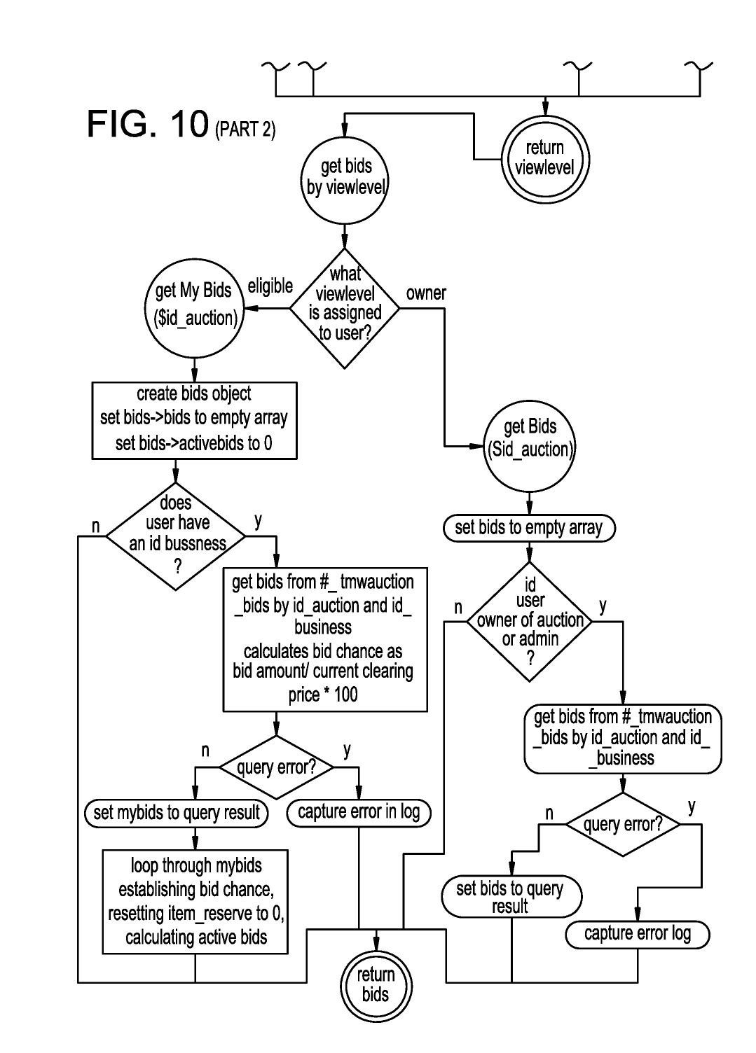

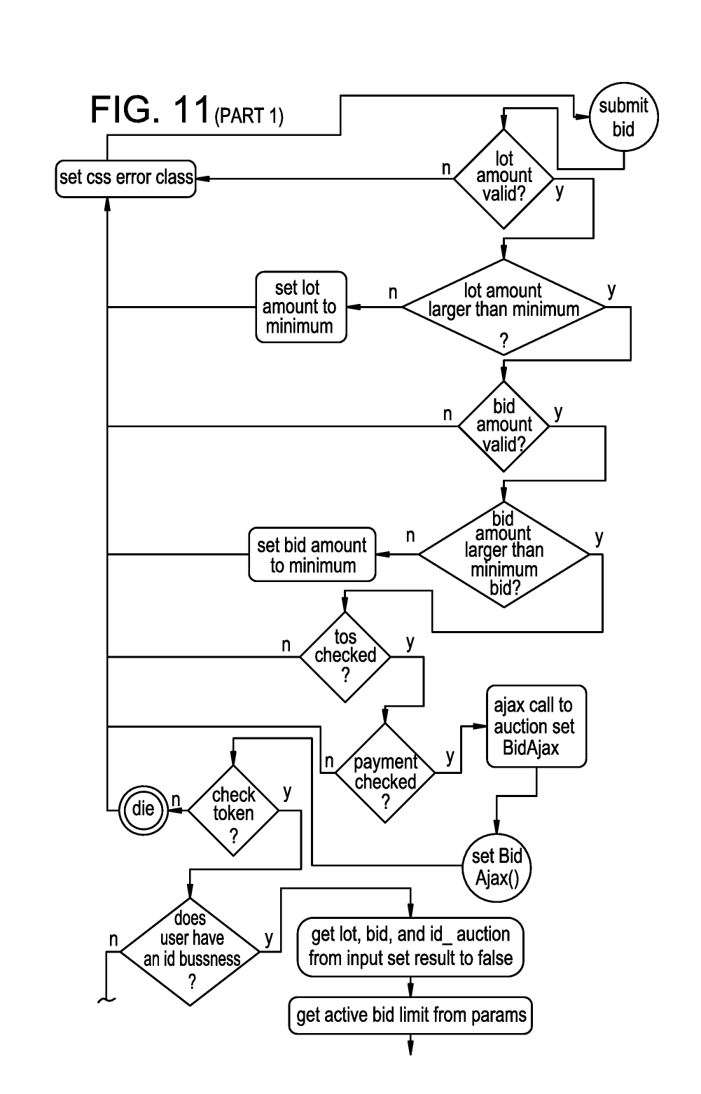

FIGS. 10-12 illustrate flow charts that depict exemplary embodiments of a bidding process in the auction system. As shown in FIG. 10, among other features, a total bid count and information of bids on the auction entry may be displayed. For a guest user, a portion of the bid information may be filtered. The chart in FIG. 10 references the buyer, and is seller agnostic. Similar to the seller, the buyer can also be validated to confirm the buyer is eligible to participate in the particular auction, for instance based on the location of the buyer.

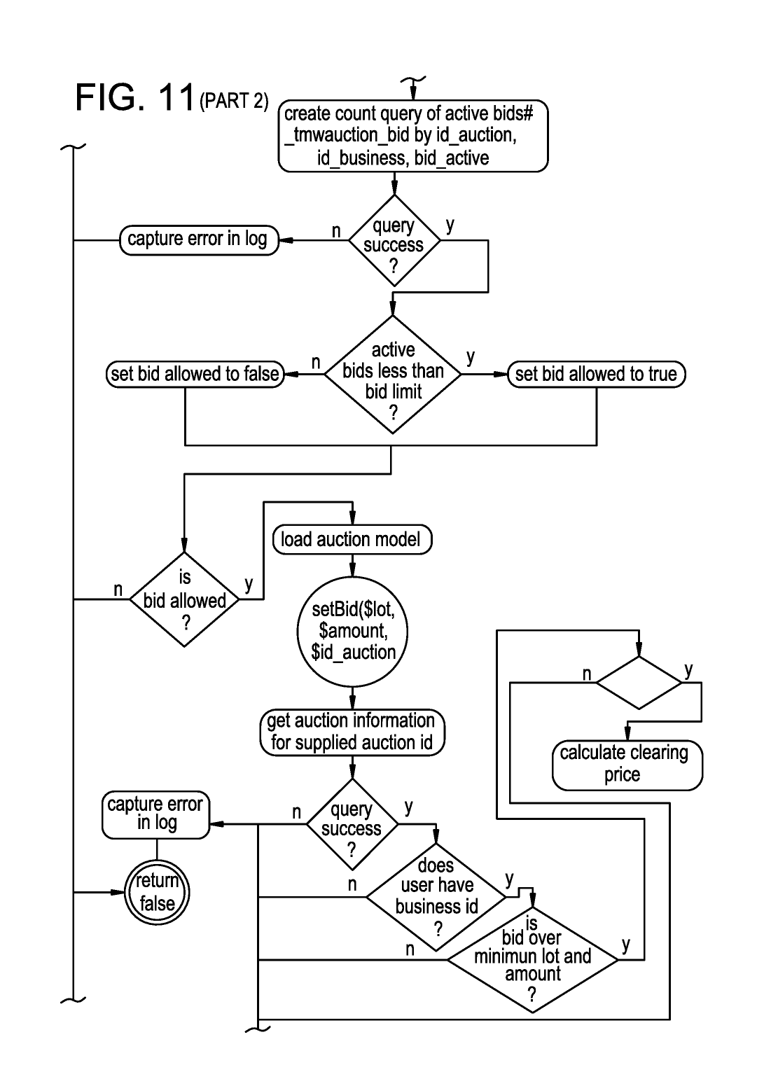

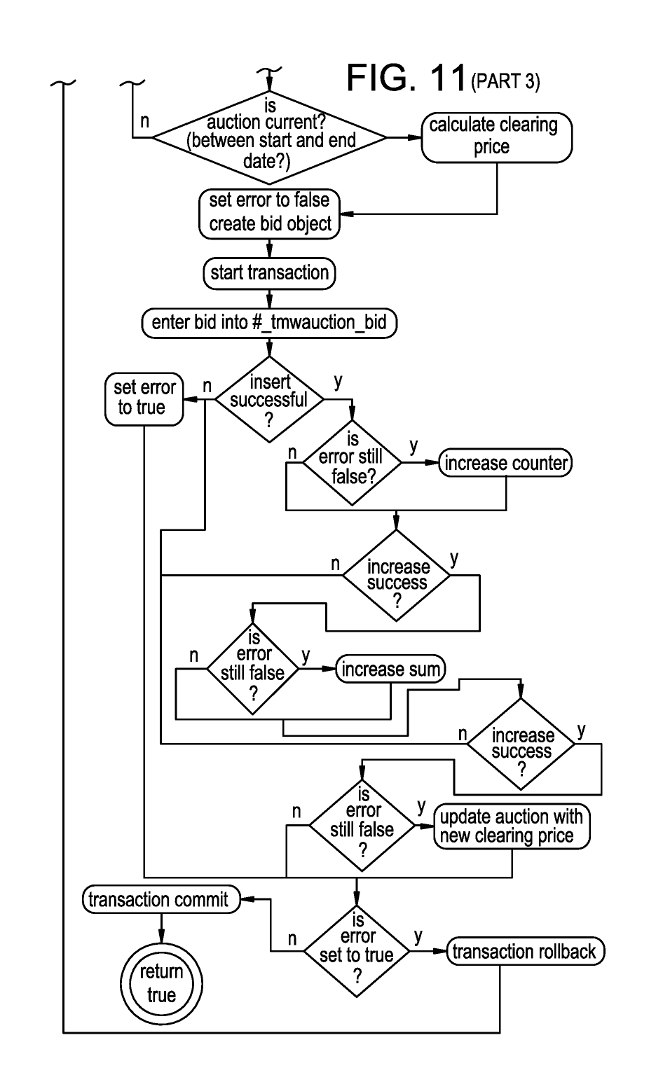

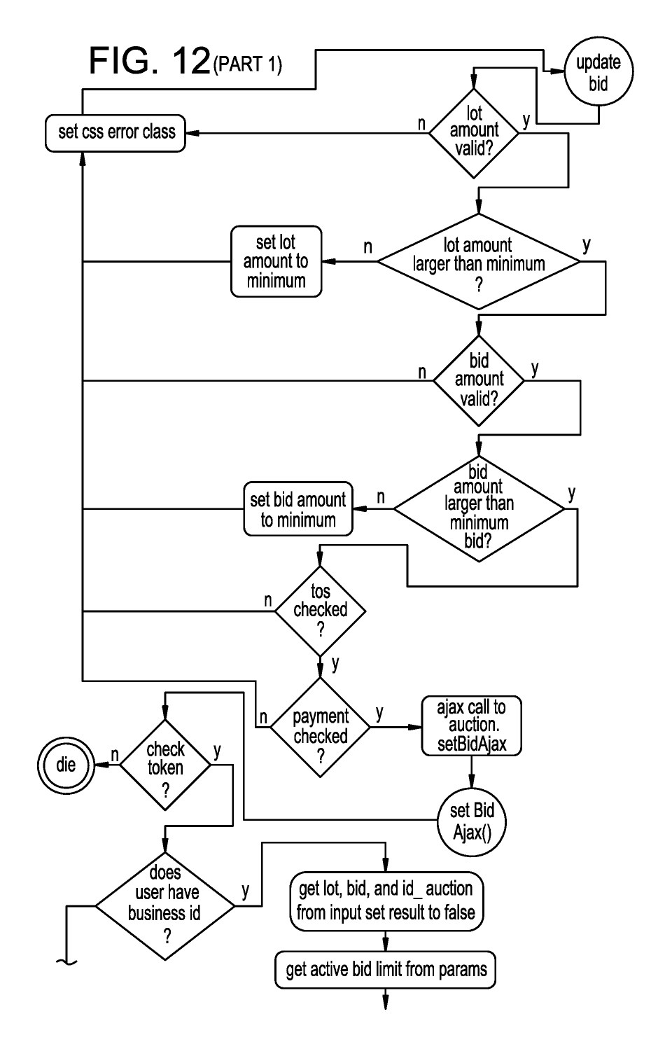

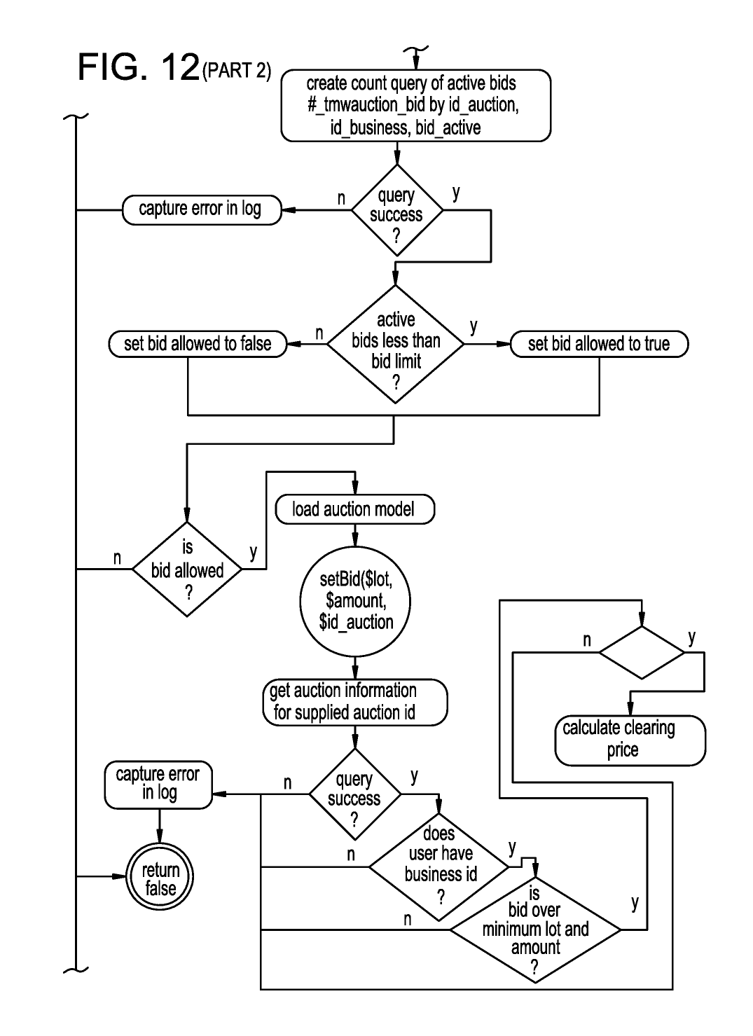

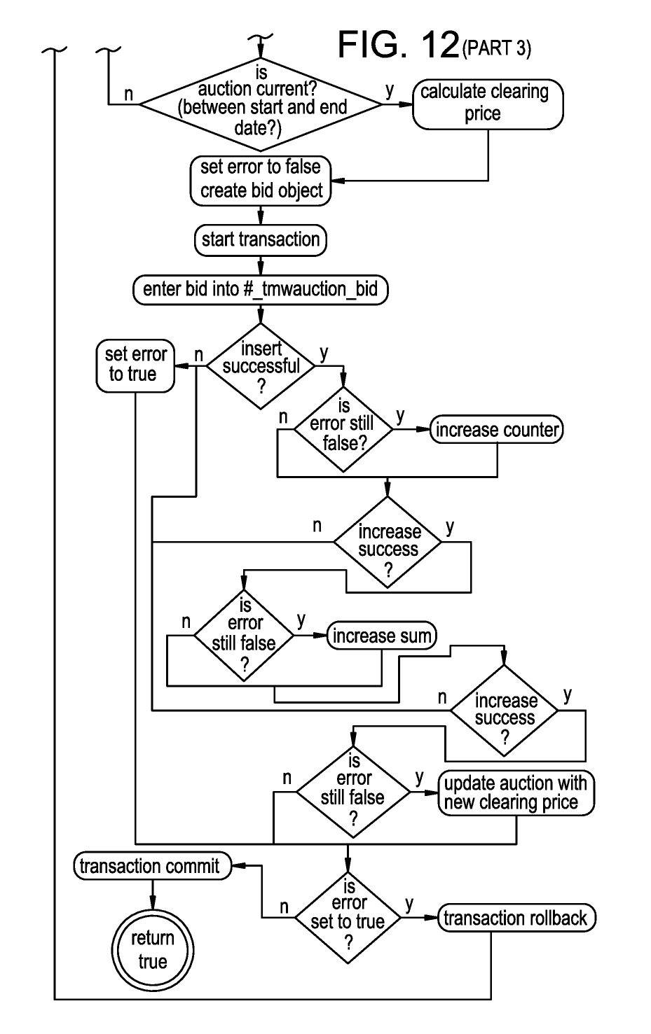

As shown in FIG. 11, a buyer may submit a bid for an auction entry. Among other features, if an order amount of the bid is greater than a lot size of the auction entry or a bid price is smaller than a pre-determined minimum bid price, the values may be properly adjusted on the seller's end. As shown in FIG. 12, among other features, a buyer may update an existing bid before a corresponding auction ends. Additional details about the bidding process from both the buyer's and seller's perspective can be discerned from the flow charts of FIGS. 10-12 by a person skilled in the art, as well as in view of the descriptions and illustrations provided for with respect to FIG. 6, among other disclosures provided for herein.

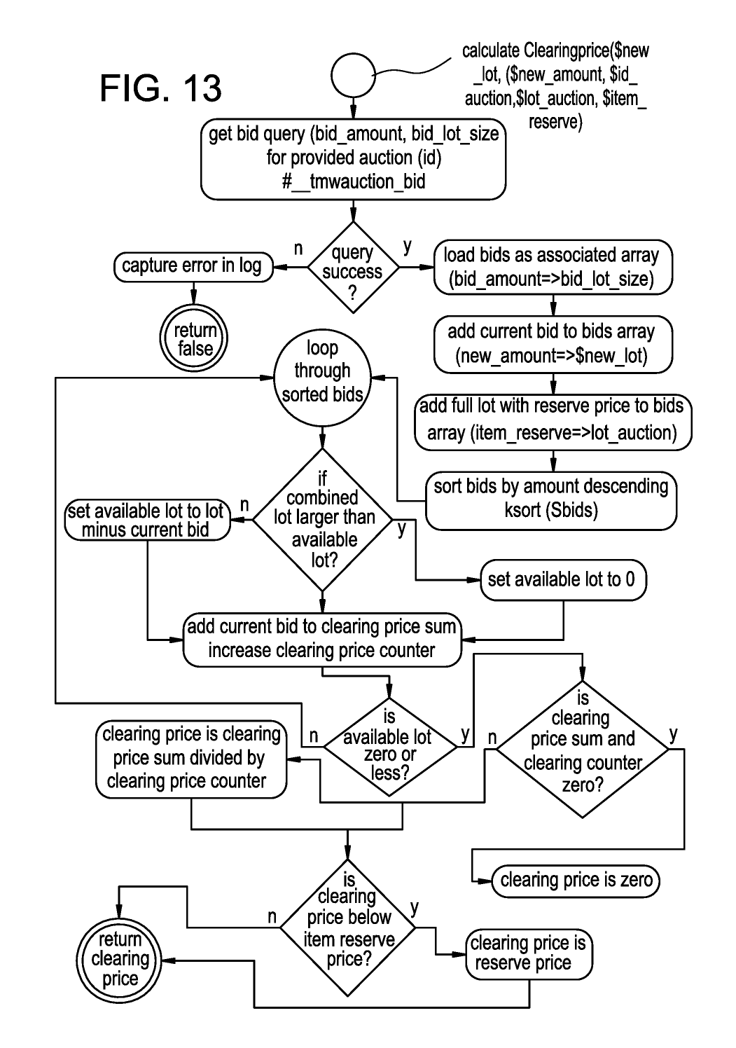

FIG. 13 illustrates a flow chart that depicts one exemplary embodiment for calculating a price for an auction entry, also referred to as a price discovery tool. It allows the marketplace to allocate the appropriate price for the good being sold. As shown in FIG. 13, among other features, bids on an auction entry may be sorted into a bid array in a descending order according to their bid prices. Until their combined order amount is bigger than the lot size of the auction entry, bids in a descending order from the top bid of the bid array are selected. Based on the selected bids, a clearing price (i.e., a sale price) for the auction entry is calculated. Notably, the calculation is agnostic to a lot size. When the calculated clearing price is lower than a reserve price, the clearing price is set to the reserve price of the auction entry. The auction and bidding process can serve as a Dutch-style auction, benefiting the seller by calculating a fair market value price for the goods, and benefiting the buyer by insuring the buyer equal access to any good for which the buyer is legally permitted to purchase. Additional details about the price discovery tool can be discerned from the flow chart of FIG. 13 by a person skilled in the art, as well as in view of the descriptions and illustrations provided for with respect to FIG. 7, among other disclosures provided for herein.

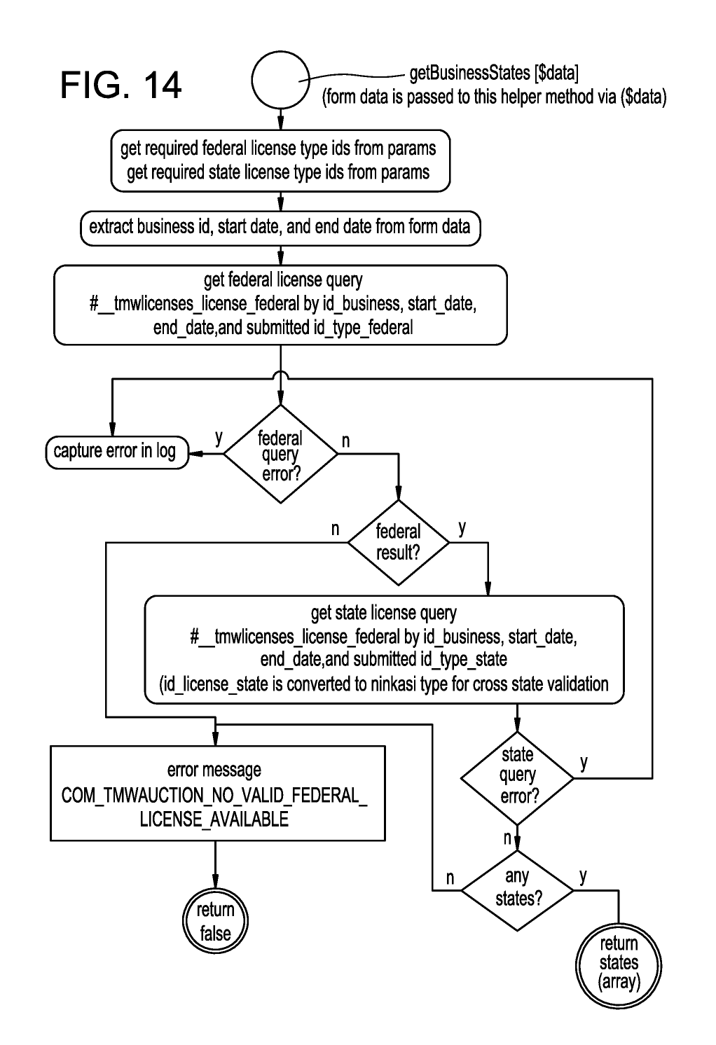

Additional information about various verifications that can be performed by the disclosed system are provided for in FIGS. 14-17. FIG. 14, for example, provides for steps associated with verifications related to determining a business state for a user. Illustrated steps include obtaining information such as federal and state licenses, and extracting relevant data (e.g., business ID, start date of license, end date of license) to confirm the license is valid and the user is authorized to participate as either a buyer and/or seller as needed. The information can be provided by any known means, including linking to data provided from various agencies that include the data, public records, and the like.

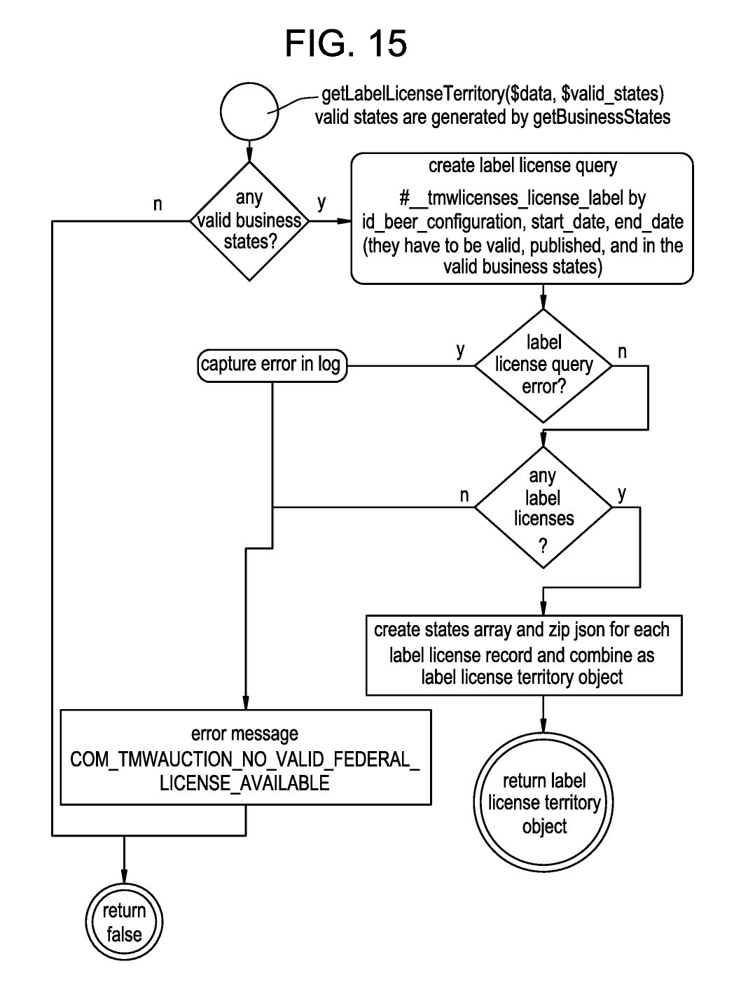

FIG. 15 provides for steps associated with determining a label and license territory for a user. Illustrated steps include determining if there are any valid business states, and if so, creating a label license query, obtaining any label licenses in view of the query, and then creating data (e.g., states array and zip) for each label license record to combine to create a label license territory object. The resulting label license territory object is then returned to the system and/or user. As with all of the more detailed flow charts provided for with respect to FIGS. 9-17, the flow charts account for how to respond to various errors that may be generated during the work flow process. A person skilled in the art will understand other work flow arrangements that can be made to identify, communicate, and resolve errors in association with any of the work flows provided for in the present disclosure.

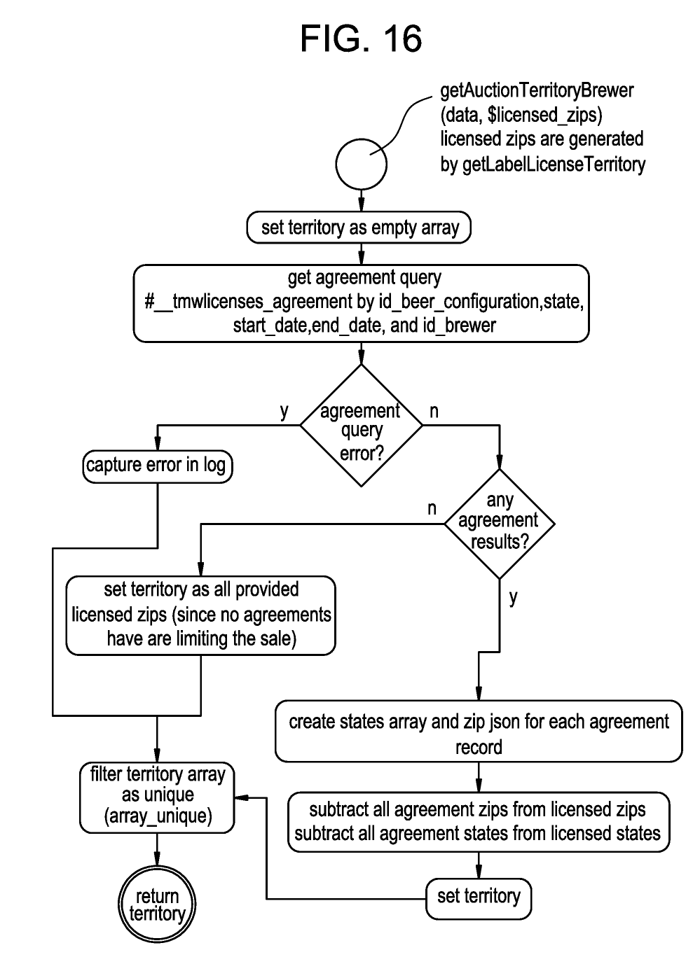

FIG. 16 provides for steps associated with determining an auction territory for an artisan. As illustrated, the information associated with the artisan can be related to any agreements involving the artisan. If the artisan has agreements to operate in particular territories, the system can determine which territories they are from a database that includes that information, with that information being based on such known agreements. Like the other information provided for in the present disclosure, there are many ways by which this information can be obtained, including through various agencies, governments, public information, etc. For any of the provided work flows, a person skilled in the art will understand how the information can be obtained to be used in conjunction with actions such as obtaining, verifying, and other actions accounted for in the flow charts. As shown in the flow chart, various cross-checks are made to narrow the list of authorized territories until the accurate territory is set for the artisan.

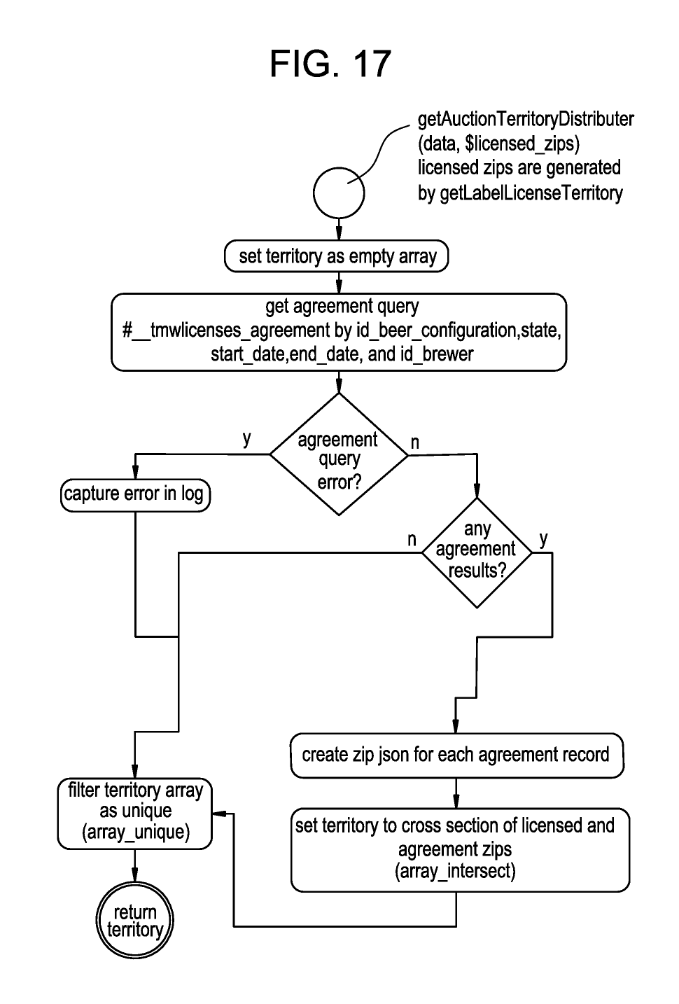

FIG. 17 provides for steps associated with determining an auction territory for a distributor. These steps are similar to those described above for the artisan with respect to FIG. 16. Data or information from distributor agreements are reviewed and analyzed by the system, lists are created and filtered to create a list of territories in which the distributor can participate. Likewise, flow charts of this nature can be applicable to any type of user of the system, and such adaptation is within the skill of a person skilled in the art in view of the present disclosures.

The technology platform provided for by the present systems and methods allows for, among other things, auctions sales, which can be used for the sale of limited edition productions of a good, previous vintages, and excess inventory. It can also allow for fixed price sales, future sales (pre-payment for a product already in production but not yet complete for example), options sales (options to purchase a product that is in-production or to-be produced for example), and reverse auctions (which can be used, for example, by chains and larger purchasers to allow small brewers to bid on plan-o-gram placements across multiple units). The systems and methods provided for herein can also allow for the creation of a nation-wide network of “public warehouses.” This, in turn, can allow for products to be pre-positioned for sale, to be delivered quickly upon purchase, and to be allocated and/or re-allocated where demand is highest. It can also minimize paperwork.

In general, the technology platform provided for by the present systems and methods bring together licensed sellers and buyers in each state, territory, nationally, and even internationally. Using the beer industry as a non-limiting example for the marketplace, for brewer to distributor sales and transactions, the systems and methods can act as the electronic broker/salesperson for the brewer. This can allow the brewer to sell limited editions of a particular brew for a particular brand or brewer that a distributor sales force may not be able to sell and advertise for as well as the brewer can do itself. The present systems and methods can act more broadly as a brewer's online point-of-sale system, for instance if the brewer does not want to make such a considerable investment itself, such that the brewer does not have to maintain or leverage the online point-of-sale system itself. The present systems and methods can allow the proprietor of the systems and methods to serve as a brewer's sales team, for instance when the brewer is self-distributing and/or when the brewer is entering a new territory. Further, the systems and methods also provide compliance services.

For distributor to retailer sales and transactions, the systems and methods can act as the electronic broker/salesperson for the distributor who has the brand. This can allow the distributor to sell limited editions of a particular brew for the particular brand it distributes that a retail sales force may not be able to sell and advertise for as well as the distributor (or brewer) can do itself. The present systems and methods can act more broadly as a distributor's online point-of-sale system, for instance if the distributor does not want to make such a considerable investment itself, such that the distributor does not have to maintain or leverage the online point-of-sale system itself. Again, further, the systems and methods also provide compliance services.

For distributor to distributor sales and transactions, the systems and methods can help distributors of a particular brand optimize inventories and keep product fresh. The systems and methods also provide compliance services.

For importer to distributor sales and transactions, the systems and methods can act as the electronic broker/salesperson for the importer. Further, the systems and methods also provide compliance services. Still further, the systems and methods can help importers maximum price for its products, including but not limited to for rare, vintage, or limited edition products.

For exporter to distributor in other countries sales and transactions, the systems and methods can act as the electronic broker/salesperson for the exporter. Further, the systems and methods also provide compliance services. Still further, the systems and methods can combine brewers exports to obtain preferential shipping rates.

For chain store to brewer sales and transactions, as well as chain store to state-wide distributor sales and transactions, the systems and methods provide a reverse or Dutch-style auction model, and can be adapted to operate in other sales methods as well in view of the present disclosures and knowledge of those skilled in the art. The systems and methods can act as the electronic broker/salesperson for the chain store, and can also provide compliance services.

A person skilled in the art will understand that some of the various benefits of the systems for different contact points in the distribution chain (e.g., brewers, distributors, retailers, consumers, etc.) can also be applicable to some of the other contact points, depending on which contact point is the buyer and seller at a particular point in time. Accordingly the features and benefits described between two different contact points may be applicable to other relationships. A person skilled in the art would understand how the features and benefits can be applicable to other such relationships. Further, a person skilled in the art, in view of the provided flow charts, present disclosures, and knowledge in the art will understand how the different features of the provided for systems and methods work together to allow for the auction, pricing determination, and ultimate sale and distribution of the regulated goods to be performed.

The advantages that stem from the present disclosure are many. The portions of the systems and methods that allow for price discovery allow users to maximize value of their products, particularly when the products are limited editions, vintage, collaboration creations, and/or other artisan works. The portions of the systems and methods that allow for distribution allocation allow users to maximize brand and product exposure to easily pull through to consumers. The systems and methods provided for herein are further advantageous for artisans in particular because of the broad access to the market it provides while still allowing the artisans tailored treatment. For example, the proprietor of the systems and methods provided for herein can work directly with artisan and/or can act as the sales technology platform for artisans and distributors alike. The artisan can use the technology platform for all of its goods, or just use it for specific products, and likewise distributors can use the technology platform for all of its goods, or just use it for specific brewers and/or products. Still further, the systems and methods allow users to go outside the established, and rather restrictive, goods (e.g., beer) distributor network to build a custom distribution network for the artisan. In instances in which the proprietor is acting as an artisan's distributor in a particular state or locality, the proprietor can also provide artisan-friendly distribution agreements.

Yet another benefit of the present systems and methods is the observation deck it provides for consumers to obtain more information about fair market value for a particular good. Consumers can observe the auctions (although they can be prevented from viewing the pricing scheme as described herein or otherwise designed by the seller) and follow the beer to purchase it themselves. Still further, the data created by the systems and methods can, in turn, be monetized by the proprietor. By providing more visibility to consumers, artisans can use the systems and methods to build its own brand and advertising that it otherwise would not have been able to attain.

One skilled in the art will appreciate further features and advantages of the disclosure based on the above-described embodiments. Accordingly, the disclosure is not to be limited by what has been particularly shown and described, except as indicated by the appended claims. All publications and references cited herein are expressly incorporated herein by reference in their entirety.

What is claimed is:

1. A method for setting up one or more sale transactions on an auction system, the method comprising:
receiving information of a plurality of auction entries from one or more sellers of a plurality of sellers through a user interface of the one or more sellers, wherein the information includes a lot size of an auction entry of the plurality of auction entries;
selecting at least one auction entry from the plurality of auction entries for one or more buyers of a plurality of buyers being logged into the auction system;
receiving one or more bids from at least one buyer of the one or more buyers through a user interface of the at least one buyer for the at least one selected auction entry;
selecting one or more bids among the one or more received bids for the at least one selected auction entry;
generating one or more sale transactions for the at least one selected auction entry between a corresponding buyer of the plurality of buyers and a corresponding seller of the plurality of sellers; and
informing the corresponding buyer and the corresponding seller of the at least one selected auction entry of the generated one or more sale transactions.

2. The method of claim 1, wherein selecting at least one auction entry from the plurality of auction entries for one or more buyers of a plurality of buyers being logged into the auction system further comprises selecting at least one auction entry from the plurality of auction entries in view of government regulations applicable to a good being sold in conjunction with the at least one auction entry.

3. The method of claim 1, wherein the bid comprises a bid price, an order amount, and a desired sale location.

4. The method of claim 3,
wherein the one or more received bids is a plurality of received bids, the selecting one or more bids among the plurality of received bids for the at least one auction entry further comprises:
ordering the plurality of received bids in a descending order of the bid price; and
selecting at least one bid of the plurality of received bids until a total amount of the order amount of the at least one selected bid exceeds the lot size of the corresponding auction entry.

5. The method of claim 4, wherein a sale price for the generated sale transaction is determined according to the bid prices of the selected bids.

6. The method of claim 5, wherein the sale price for the generated sale transaction is the same as the bid price for the corresponding bid or the sale price is the same as the lowest bid price of the at least one selected bid.

7. The method of claim 4, wherein selecting at least one bid of the plurality of received bids further comprises selecting one or more bids from the plurality of received bids that are equal to or greater than a reserve price of the corresponding auction entry.

8. The method of claim 1, wherein the information of an auction entry further comprises a flag for allowing a partial sale and, if a partial sale of an auction entry is not allowed and the total amount of selected bids does not exceed the lot size of the auction entry, no sale transaction is created.

9. A system for setting up one or more auction sale transactions, the system comprising:
a storage device configured to receive and store information related to a plurality of auction entries from one or more sellers of a plurality of sellers, the information including a lot size of each auction entry; and
a processor in communication with the storage device to allow the processor to access and perform various functions in view of the information stored by the storage device, the processor configured to:
access the information from the storage device;
select at least one auction entry from the plurality of auction entries for each buyer of a plurality of buyers being logged into the auction system;
receive one or more bids from one or more buyers of the plurality of buyers for the at least one selected auction entry;
select one or more bids among the one or more received bids for the at least one selected auction entry;
generate one or more sale transactions for the at least one selected auction entry between a corresponding buyer of the plurality of buyers and a corresponding seller of the plurality of sellers; and
inform the corresponding buyer and the corresponding seller of the at least one auction entry of the generated one or more sale transactions.

10. The system of claim 9, wherein the processor is further configured to select at least one auction entry from the plurality of auction entries for each buyer of a plurality of buyers being logged into the auction system in view of government regulations applicable to a good being sold in conjunction with the at least one auction entry.

11. The system of claim 9, wherein the bid comprises a bid price, an order amount, and a desired sale location.

12. The system of claim 11, wherein the one or more received bids is a plurality of received bids, and
wherein the processor further orders the plurality of received bids in a descending order of the bid price and selects at least one bid of the plurality of received bids until a total amount of the order amount of the selected bids exceeds the lot size of the corresponding auction entry.

13. The system of claim 12, wherein a sale price for the generated sale transaction is determined according to the bid prices of the selected bids.

14. The system of claim 13, wherein the sale price for the generated sale transaction is same as the bid price for the corresponding bid or the sale price is the same as the lowest bid price of the at least one selected bid.

15. The system of claim 12, wherein the selection of at least one bid of the plurality of received bids is performed such that selected bids are bids that are equal to or greater than a reserve price of the corresponding auction entry.

16. The system of claim 9, wherein the information of an auction entry further comprises a flag for allowing partial sale and, the processor is configured such that if partial sale of an auction entry is not allowed and the total amount of selected bids does not exceed the lot size of the auction entry, no sale transaction is created.

17. A method for setting up one or more sale transactions on an auction system, the method comprising:
generating a plurality of auction entries for a plurality of batches of sales;
for each user being logged into the auction system, selecting one or more of the plurality of auction entries considering regulations governing sales between the user and a seller of each of the plurality of auction entries;
receiving bids from the user for one or more auction entries, the bids including a bid price and an order amount;
for each of the plurality of auction entries, selecting one or more bids among the received bids for the auction entry with the bids being disposed in a descending order of the bid price of the received bids until a sum of the corresponding order amount exceeds an amount of the auction entry, and determining a sale price for the auction entry based on the selected bids; and
setting up one or more sale transactions for each of the plurality of auction entries having a determined sale price between a corresponding user and the seller of the auction entry.

18. The method of claim 17, wherein selecting one or more bids among the received bids for the auction entry further comprises selecting one or more bids that are equal to or greater than a reserve price of the corresponding auction entry.

19. The method of claim 17, wherein information of an auction entry of the plurality of auction entries further comprises a flag for allowing a partial sale and, if a partial sale of an auction entry is not allowed and the total amount of selected bids does not exceed the lot size of the auction entry, no sale transaction is created.
